(19) United States
(12) Patent Application Publication
(10) Pub. No.: US 2016/0330794 A1
(43) Pub. Date: Nov. 10, 2016

(54) Seamless Collaborative Music Playback of Multiple Devices

(71) Applicants: Fulya Ozcan, Irvine, CA (US); Cesar Ghali, Irvine, CA (US); Sky Faber, Irvine, CA (US); Ekin Oguz, San Francisco, CA (US)

(72) Inventors: Fulya Ozcan, Irvine, CA (US); Cesar Ghali, Irvine, CA (US); Sky Faber, Irvine, CA (US); Ekin Oguz, San Francisco, CA (US)

(21) Appl. No.: 14/946,557

(22) Filed: Nov. 19, 2015

Related U.S. Application Data
(60) Provisional application No. 62/159,051, filed on May 8, 2015.

(51) Int. Cl. H04W 84/20; H04L 29/08; H04L 29/06; H04L 12/24

(52) U.S. Cl. CPC H04W 84/20; H04L 41/0803; H04L 67/104; H04L 65/4069

(57) ABSTRACT

A method to enable users to listen to music from multiple devices collaboratively without the use of the internet. A wireless ad hoc peer-to-peer network is created among multiple devices, where one device functions as a master device and the other devices function as client devices. The master device functionality can be rotated among the devices so that there is no need for a permanent master device. Audio files from multiple devices in the network are then added to a common playlist so that the audio files are streamed from the corresponding devices to the master device so that users in close proximity can listen to that common playlist from one single speaker. This invention allows users to listen to music simultaneously from various devices, without the need to swap the device that is connected to the speaker.

### CROSS-REFERENCE TO RELATED APPLICATIONS

This application claims the benefit under 35 USC 119 of U.S. Provisional Application Ser. No. 62/159,051 filed on May 8, 2015, entitled “BeatPool,” which is incorporated herein by reference.

### FIELD OF THE INVENTION

The invention relates to the field of wireless communication networks and data processing systems or methods—commerce. CPC H04W, G06Q 30/00

### BACKGROUND OF THE INVENTION

There are many music listening applications that are available for devices, none of which allows the users in close proximity to instantly interact with a common playlist. One major music listening application allows users to create a playlist together, but it requires users to be online. However, this has two main restrictions. First, because it requires users to be online, users cannot contribute to the common playlist without an internet connection. Second, it does not work as a proximity based common playlist and does not allow users to modify the ongoing playlist, which is being played through a common speaker.

### BRIEF SUMMARY

The present invention enables users to listen to music from multiple devices collaboratively without the use of the Internet. This music listening application allows users to create their own playlists from either the content that they already have in the it music libraries or from online music contents. The present invention enables users of the music listening application installed on their device to listen to music collaboratively. Device here refers to any device that has some proximate communication means. More specifically this invention allows users in close proximity to create and modify a common playlist via their own devices and listen to that playlist from one single or common speaker with no interruptions. This invention allows users to listen to music simultaneously from various devices, without the need to swap the device that is connected to the speaker. This eliminates undue interruptions caused by disconnecting and reconnecting to the speaker or stereo system.

One embodiment incorporates a collaboration feature in a music listening application for devices which enables users in close proximity to each other to create or join a common playlist (pool), and modify this pool using their own devices, while the common playlist is being played through one single or common speaker. The invention does not require the internet to connect the users. The invention uses communication modes that are already embedded in devices to create a wireless ad hoc peer-to-peer network to interconnect any users in close proximity who wish to join the pool.

There are three main functionalities of the invention. The user can use the application to listen to music by herself. However, the user can create a pool in her own device for other devices in close proximity to join, or the user can search for pools in close proximity and join them. By joining a pool, users can pick songs from their own devices, which plays through a master device that initially created the common playlist. By allowing songs from different devices to be played through only one device, users can access music on different devices via one common playlist, instead of switching to different devices to play music from those devices. Users who have joined a common pool can add songs from their own libraries to the ongoing queue, change the order of existing songs in the pool, remove songs from the pool, adjust the volume and make other modifications. The songs from various users' devices are streamed to one playback speaker only. The songs sent from different users are only streamed from the speaker, not saved in any other device. This invention also allows library integration between devices and playing from multiple speakers at once. Moreover, it is also possible to play a pool over the internet among many users (poolers) simultaneously.

There are different play modes of this invention. The regular mode allows each user to add as many songs to the playlist as she would like, and the songs are played depending on the time of the inclusion to the playlist. Another mode is round-robin where only one song per user played in a round. Majority voting is another option where the users can add songs to the pool, vote for the songs they would like to hear, and the order of the songs in the playlist is determined according to how many votes each song gets, regardless of which user added it to the playlist. First-come first-played is another mode where songs are played in the order that they are added to the playlist.

In summary, the illustrated embodiments of the invention include a method which includes the steps of creating a wireless ad hoc peer-to-peer network among a plurality of devices, wherein one of the plurality of devices functions as a master device and at least one of the plurality of devices functions as a client device, each of the devices having at least one audio data file stored therein, creating a common playlist of a plurality of audio data files from the plurality of devices in the master device, and serially streaming selected ones of the plurality of audio data files from the corresponding ones of the plurality of devices to the master device in an order determined by the common playlist.

The method further includes the step of playing the audio data file through an audio output source in or communicated with the master device.

The method further includes the step of integrating the functionality of the master device into an audio output source.

The method further includes the step of allowing the master device to designate one of the client devices as a successive master device so that the master device functionality is rotated among the plurality of devices.

The step of creating the common playlist of a plurality of audio data files from the plurality of devices in the master devices includes the step of saving the common playlist in each of the plurality of devices.

The method further includes the step of specifying in the master device which of the client devices can access the common playlist and the degree to which the client devices can modify the common playlist.

The scope of the illustrated embodiments also include a method for targeted advertising, which includes the steps of creating a wireless ad hoc peer-to-peer network among a plurality of devices, wherein one of the plurality of devices functions as a master device and at least one of the plurality of devices functions as a client device, each of the devices having at least one audio data file stored therein, and at least one of the devices having at least one advertisement file stored therein, creating a common playlist of a plurality of audio data files from the plurality of devices in the master device, serially streaming selected ones of the plurality of audio data files from the corresponding ones of the plurality of devices to the master device n an order determined by the common playlist, and transferring the advertisement file from the corresponding one of the plurality of devices to at least another one of the plurality of devices in the wireless ad hoc peer-to-peer network.

The step of transferring the advertisement file includes the step of transferring the advertisement file at a selected infection rate from the corresponding one of the plurality of devices to at least another one of the plurality of devices.

The step of transferring the advertisement file at a selected infection rate includes the step of transferring the advertisement file at a selected infection rate determined according to a tiered advertiser schedule.

The method further includes the step of setting the duration, according to a selected durability rate, that the advertisement files are stored on the plurality of devices before they are deleted.

The step of setting the duration, according to a selected durability rate, includes the step of setting the duration, according to a selected durability rate, is determined according to a tiered advertiser schedule.

The method further includes the step of playing the advertisement files at a selected advertisement frequency rate on the plurality of devices.

The step of playing the advertisement files at a selected advertisement frequency rate comprises playing the advertisement files at a selected advertisement frequency rate determined according to a tiered advertiser schedule.

The method further includes the step of playing the audio data file through an audio output source in or communicated with the master device.

The method further includes the step of integrating the functionality of the master device into an audio output source.

The method further includes the step of integrating the functionality of the master device into an audio output source.

The method further includes the step of allowing the master device to designate one of the client devices as a successive master device so that the master device functionality is rotated among the plurality of devices.

The method further includes the step of specifying in the master device which of the client devices can access the common playlist and the degree to which the client devices can modify the common playlist.

The scope of the illustrated embodiments of the invention also includes a device for use in a system combining a plurality of such devices in a wireless ad hoc peer-to-peer network, one of which plurality of devices is designated as a master device having a playlist stored therein. The device includes a device discovery module to find the one of the plurality of devices designated as the master device, a queue for storage of the playlist, a queue service module to synchronize with the playlist in queue of the master device, a library module that provides an interface with the music library database, wherein the music library database is a storage for a plurality of audio files, a communication module to send and receive information among the plurality of devices, a tangible storage medium for storing information about queues, audio files, and connected devices in the ad hoc network, a database module to interface with the tangible storage medium, an audio service module to manage output of audio playback, and a song data source to stream an audio file to the queue service module, the queue service module communicating the audio file to the audio service module.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112.The disclosure can be better visualized by turning now to the following drawings wherein like elements are referenced by like numerals.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagram which illustrates a system comprising a plurality of devices connected in a wireless ad hoc peer-to-peer network to allow audio data files from any of the devices to be streamed to the master device according to one embodiment of the invention.

FIG. 2 is a flow diagram of the collaborative music playback process with targeted advertising according to another embodiment of the invention.

FIG. 3 is a diagram of a representative splash screen of a smart phone that can be presented according to one embodiment.

FIG. 4 is a diagram of a representative screen of a queue page on a smart phone of a common playlist according to one embodiment.

FIG. 5 is a diagram of a representative screen of a smart phone of a users content library according to one embodiment.

FIG. 6 is a diagram of a representative screen of a smart phone of a common playlist after multiple audio files have been added according to one embodiment.

FIG. 7 is a diagram of a representative screen of a smart phone of a navigational menu according to one embodiment.

FIG. 8 is a block diagram which shows the application modules and all its components according to one embodiment of the invention.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION

The phrases “in one embodiment”, “in various embodiments”, “in some embodiments”, and the like are used repeatedly. Such phrases do not necessarily refer to the same embodiment. The terms “comprising”, “having”, and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to or combined, without limiting the scope to the embodiments disclosed herein.

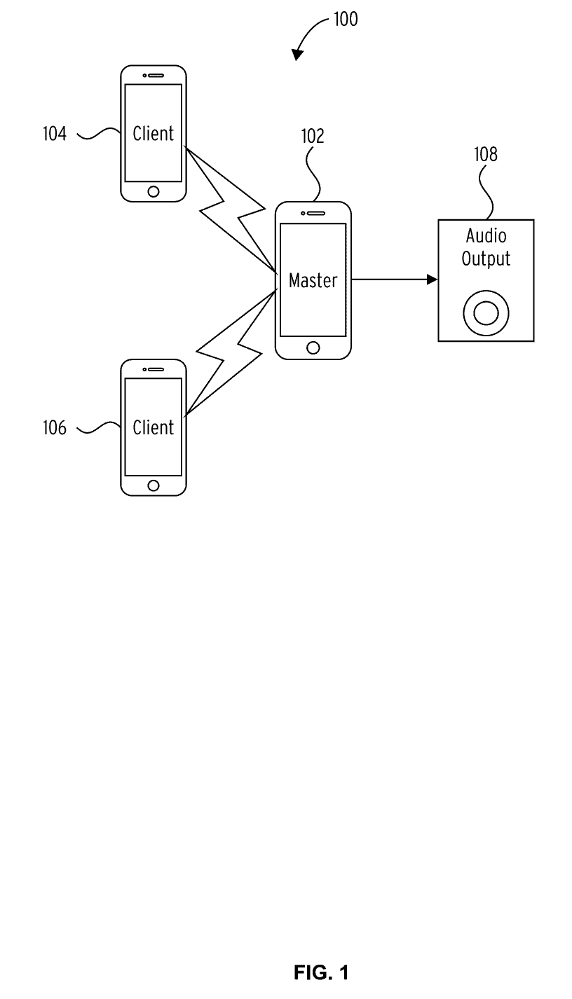

FIG. 1 is a simplified diagram of a wireless ad hoc peer-to-peer network 100 according to one embodiment of the invention. Client devices 104 and 106 are connected with the master device 102. The device that creates a common playlist (pool) functions as the master device 102. The devices that join the pool function as the client devices 104 and 106. Users can then add audio data files from the plurality of devices 102, 104 and 106 to the common playlist. These audio data files are then serially streamed, in an order determined by the common playlist, from the corresponding ones of the plurality of devices 102, 104 and 106 where they are stored to the master device 106. The audio file can then be played through an audio output source 108 either in or communicated with the master device 102.

Users of the invention can achieve collaborative listening of music with other users in close proximity. This can be accomplished using proximity-based wireless technologies ad hoc that are already embedded in modern devices, such as Wi-Fi and Bluetooth, and will also work for any future technology. Wi-Fi and Bluetooth can also be mixed for better discovery and connection. Users can build a queue, also called a common playlist or pool, using any accessible music, such as locally stored music files or using online content providers. When one of the plurality of devices 102, 104 or 106 disconnects from the network, all audio files from that device becomes inactive.

In one embodiment, the master device 102 can designate another one of the client devices 104 or 106 as a successive master device 102 so that the master device functionality can be handed off or rotated among the plurality of devices 102, 104 and 106 so that all the devices do not need to be connected to each other at all times. In the case the master device 102 disconnects before designating one of the client devices 104 or 106 as a successive master device 102, the client devices 104 and 106 can go into an election mechanism to designate one of them as a successive master device 102. This can take place automatically in the background without user input or knowledge. In another embodiment, the common playlist can be saved in each of the plurality of devices 102, 104 and 106 so that if the master device 102 is no longer in the network 100, a device that was previously the client device, either 102 or 104, can load this saved common playlist and assume the master device functionality.

In another embodiment, the functionality of the master device 102 can be integrated into an audio output source 108 so that a separate device is not needed to function as a master device 102. This may result in a physical device such as a speaker that includes the master device functionality. This self-powered speaker may be useful for outdoor activities such as barbequing in the backyard or even camping trips. It is also useful for indoor activities where an existing speaker, such as a home stereo system, is not available.

Another embodiment of this invention is a device that can turn any audio output source 108 into a master device 102. This can be visualized as a separate device, which once connected to any audio output source 108 may allow it to function as a master device 102.

This invention can also be turned into a physical product by integrating it with car entertainment systems. Cars can be shipped with a stereo system or installed with an aftermarket stereo system capable of functioning as a master device 102. People traveling in the same car can send songs from their client devices such as 104 or 106 to the common playlist already created by the car's entertainment system.

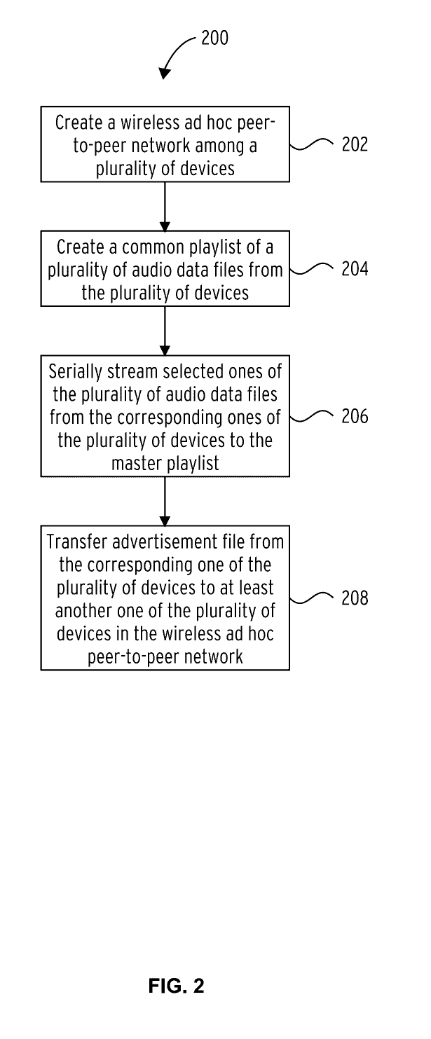

FIG. 2 is a flow diagram of the collaborative music playback process 200 with targeted advertising according to another embodiment of the invention. The collaborative music playback process 200 can be done by creating a wireless ad hoc peer-to-peer network among a plurality of devices at step 202, wherein one of the plurality of devices 102, 104 and 106 functions as a master device 102 and at least one of the plurality of devices functions as a client device 104, 106, each of the devices 102, 104 and 106 having at least one audio data file stored therein. Next, a common playlist of a plurality of audio data files from the plurality of devices 102, 104 and 106 is created in the master device 102 at step 204. Then the plurality of audio data files are serially streamed from the corresponding ones of the plurality of devices 102, 104 and 106 to the master device 102 in an order determined by the common playlist at step 204.

In another embodiment of the invention, at least one of the plurality of devices 102, 104 and 106 in the wireless ad hoc peer-to-peer network has at least one advertisement file stored therein. This advertisement file is then transferred from the corresponding one of the plurality of devices 102, 104 and 106 to at least another one of the plurality of devices 102, 104 and 106 in the network at step 208. Since this embodiment of the invention runs by creating a wireless ad hoc peer-to-peer network between devices 102, 104 and 106, without relying on any internet connection, it can be used to transfer advertisement files for targeted advertising as in step 208.

This model of targeted advertising can keep an advertising system running even without internet connection. When at least one of the plurality of devices 102, 104 and 106 is connected to the Internet, it receives advertisement files from the server having the music listening application directly. Then, the advertisement files can be transferred from one of the plurality of devices 102, 104 and 106 to at least another one of the other plurality of devices 102, 104 and 106 connected to the queue. These advertisements can be sold at different tiered advertiser schedules for different prices. These tiers may vary in: (1) Infection rate—represents the rate at which the advertisement file can be transferred and spread to other devices 102, 104 and 106; (2) Durability rate—represents the duration an advertisement file is stored on a device before it is deleted; (3) Advertisement frequency rate—represents the frequency the advertisement file is played or accessed.

In one embodiment, third party distributors can seed the advertising files. A local coffee shop can become a BeatPool advertisement distributor by setting up a master device and having its customers join the BeatPool network with their client devices. The local coffee shop can set up the network to allow its customers to either add songs or vote on preselected songs to modify the common playlist so that they can control the music that is played in the store. Advertisers can take advantage of this targeted advertisement model via BeatPool by having their advertising files stored on the master device so that they can be distributed to the customers in the pool. Retailers in close vicinity can utilize this to attract customers that are already in the area.

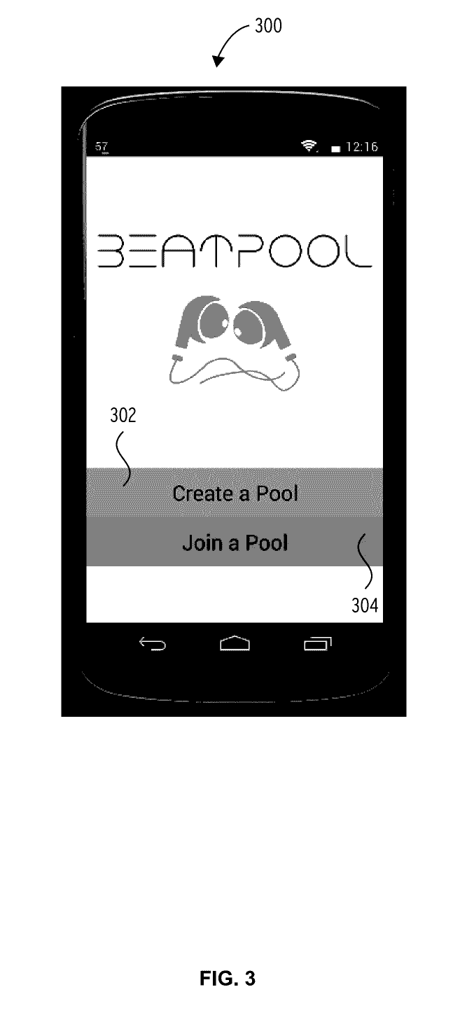

FIG. 3 illustrates a representative splash screen 300 of BeatPool on a device according to one embodiment of the present invention. After opening the application, a user may either create a common playlist by selecting option 302, which is also called a pool, or join an existing common playlist by selecting option 304. The device that creates the pool functions as a master device 102 and the devices that join the pool function as client devices 104 and 106. The audio files are streamed to the master device 102 so in one embodiment, the master device 102 can be connected to an audio output source 108 so that users in close proximity can listen to music collaboratively.

The illustrated embodiments of the invention answer the need for a device application to enable users to collaboratively listen to music stored on multiple devices or from online media sources, like Spotify or Google Play. Before this embodiment, when a group of people wanted to listen to music together, they would connect one of their devices to the speaker. This connection is usually done using an auxiliary cable or Bluetooth connection. When people needed to switch to the music stored in either the library or the online music account of another device, they first needed to disconnect the device that is currently playing from the speaker 108. Then, the new device needed to be connected to the speaker 108. One of the features of this embodiment is to eliminate the need to disconnect and connect devices from and to the speaker 108 and hence eliminate interruptions in the music.

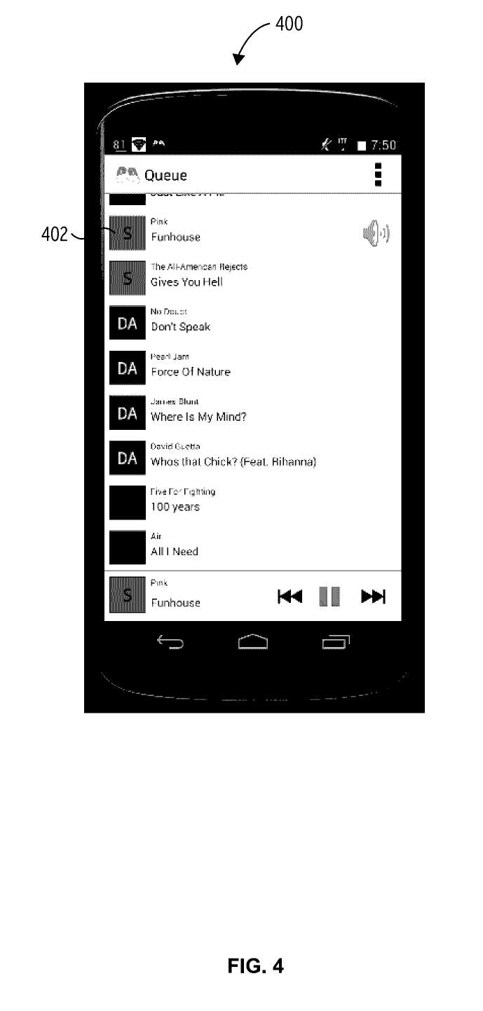

FIG. 4 illustrates a representative screen 400 of a queue page of a common playlist created by the user identified with the initial “S” in one embodiment. When users either create or join a common playlist, the queue page appears. At first, the common playlist will be empty until users add audio files to it. Also, users can create an avatar or choose customizable initials which will be displayed on the left of each song as in the thumbnail picture 402. This indicates the user who added the song to the common playlist. In one embodiment, users do not have to manually add audio files to the common playlist. Continuous playback can be set up so that audio files are randomly selected from the library of the local device or an online library.

Each user will be able to contribute, modify, and control the queue in real time. Anyone can add a song to any position in the queue, pause and play the currently playing song, skip to a specific song, or change the volume. This is accomplished by using commands distributed over the peer-to-peer network. Once a song is being played back, the device that owns the song will stream it to the master device 102 connected to a speaker 108.

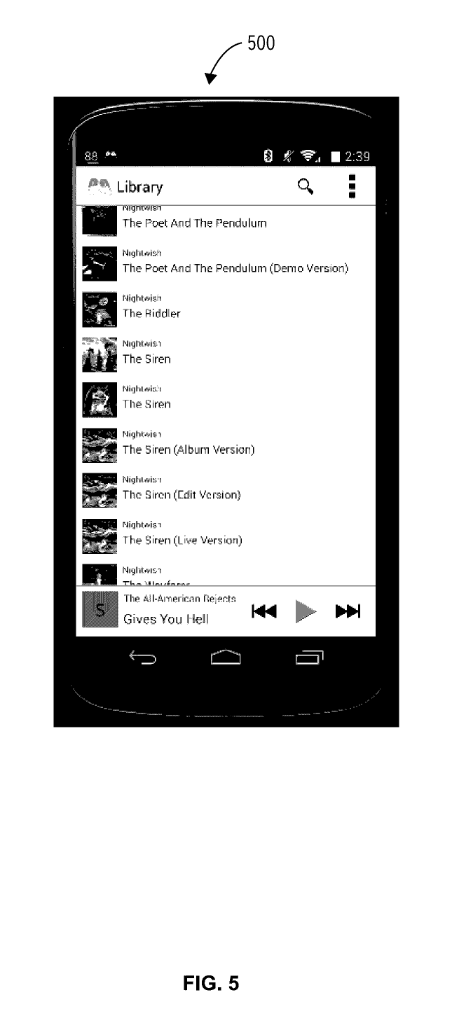

FIG. 5 illustrates a representative screen 500 of a user's content library according to one embodiment. Users can search their local music libraries for audio files to add to the common playlist.

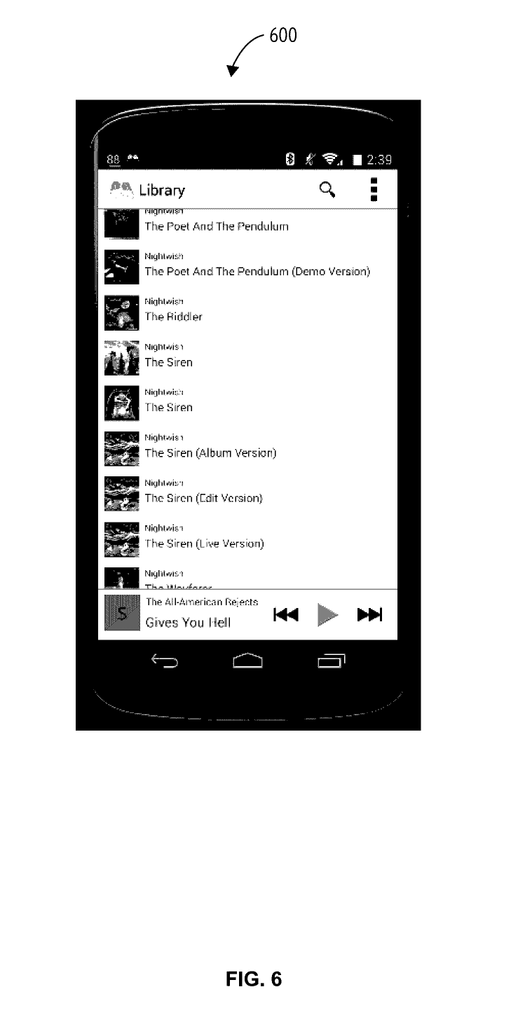

FIG. 6 illustrates a representative screen 600 of the common playlist after multiple audio files have been added to it.

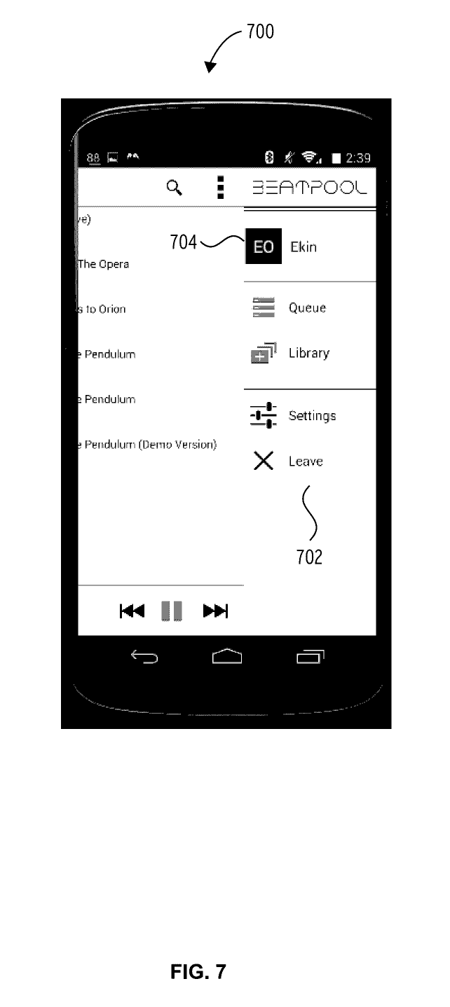

FIG. 7 shows the representative screen 700 of a navigational menu from the user Ekin's device. A user can click on the three vertical dots at the upper right corner of the screen or swipe from the edge to access the navigational menu 702. There are options to navigate between the queue, library, settings, and option to exit the application. In addition, swiping left and right switches between the library and queue screens. Moreover, the settings screen has configurable options that allow users to customize their application. They can choose a nickname, initials, and background and foreground color of the initial box 704. They can also add a personalized picture as an avatar to replace the initial box 704.

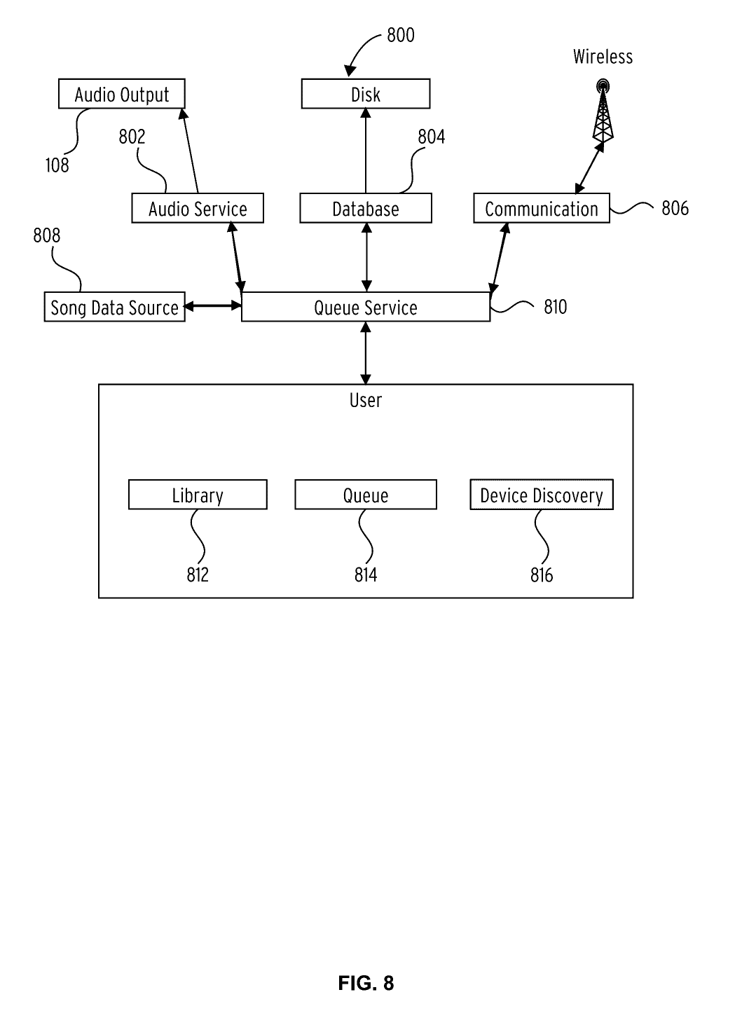

FIG. 8 shows the application modules and all its components according to one embodiment. The main user interface is a device that runs an operating system. Users' interaction with BeatPool is similar to the interaction with a media player that runs on a single device. However, there are two main differences. First, this embodiment can manage connections among multiple devices. This task is handled automatically. Second, the fact that multiple users can interact with each other imposes some restrictions on previously standard interactions. For instance, filling the pool is no longer as simple as adding all the songs from a library of a single device. Instead there are several listening modes.

There are eight modules in the device application, which manage the following functions:

1) Audio Service 802—Manages audio playback to the speaker 108.

2) Database 804—Stores information related to the queue 814, added songs, connected users, etc.

3) Communication 806—Manages connections between devices 102, 104 and 106, including special purpose communication and physical mediums.

4) Song Data Source 808—Fetches audio files from its source, e.g. local, online, etc.

5) Queue Service 810—Provides main application logic that sends and receives information, maintains the queue 814, and controls the active media.

6) UI: Library 812—Allows convenient access of available content to add to the queue 814.

7) UI: Queue 814—Displays the current queue, as reported by the Queue Service 810.

8) UI: Device Discovery 816—Shows a list of available queues 814, and manages connection requests when needed.

All changes made by one user, i.e. adding songs, starting and stopping playback, skipping songs, changing volume, changing initials, are propagated to all users automatically by the queue service 810. Queue service 810 is the core component that is responsible for maintaining a synchronized queue among the plurality of devices in the wireless ad hoc peer-to-peer network. The queue service 810 handles both backend and frontend interactions.

For the backend interactions, a communication component 806 provides interfaces to send and receive information among the plurality of devices in the network. A wireless device medium is used inside the communication component 806. A database component 804 provides interfaces to interact with a disk (not shown), where information such as queues, songs in the queues, and connected devices are stored. An audio service 802 interacts with an audio output 108 such as the speaker of the master device 102 and manages audio playback. A song data source 808 resolves song files, which will be used in audio playback.

For the frontend interactions, a device discovery 816 allows users to find available queues in the same communication medium and then connect. A queue component 814 maintains a synchronized view among all connected devices. This synchronized view includes a synchronized media playback controller, currently playing song and its state, latest state of queue, and latest state of all connected devices. A library component 812 provides an interface to interact with the user's music library. This allows users to search, find, and add music from their library to the synchronized queue.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

What is claimed is:

1. A method comprising:
creating a wireless ad hoc peer-to-peer network among a plurality of devices, wherein one of the plurality of devices functions as a master device and at least one of the plurality of devices functions as a client device, each of the devices having at least one audio data file stored therein;
creating a common playlist of a plurality of audio data files the plurality of devices in the master device; and
serially streaming selected ones of the plurality of audio data files from the corresponding ones of the plurality of devices to the master device in an order determined by the common playlist.

2. The method of claim 1 further comprising playing the audio data file through an audio output source in or communicated with the master device.

3. The method of claim 1 further comprising integrating the functionality of the master device into an audio output source.

4. The method of claim 1 further comprising allowing the master device to designate one of the client devices as a successive master device so that the master device functionality is rotated among the plurality of devices.

5. The method of claim 1 where creating the common playlist of a plurality of audio data files from the plurality of devices in the master devices comprises saving the common playlist in each of the plurality of devices.

6. The method of claim 1 further comprising specifying in the master device which of the client devices can access the common playlist and the degree to which the client devices can modify the common playlist.

7. A method for targeted advertising, comprising:
creating a wireless ad hoc peer-to-peer network among a plurality of devices, wherein one of the plurality of devices functions as a master device and at least one of the plurality of devices functions as a client device, each of the devices having at least one audio data file stored therein, and at least one of the devices having at least one advertisement file stored therein;
creating a common playlist of a plurality of audio data files from the plurality of devices in the master device;
serially streaming selected ones of the plurality of audio data files from the corresponding ones of the plurality of devices to the master device in an order determined by the common playlist; and
transferring the advertisement file from the corresponding one of the plurality of devices to at least another one of the plurality of devices in the wireless ad hoc peer-to-peer network.

8. The method of claim 7 where transferring the advertisement file comprises transferring the advertisement file at a selected infection rate from the corresponding one of the plurality of devices to at least another one of the plurality of devices.

9. The method of claim 8 where transferring the advertisement file at a selected infection rate comprises transferring the advertisement file at a selected infection rate determined according to a tiered advertiser schedule.

10. The method of claim 7 further comprising setting the duration, according to a selected durability rate, that the advertisement files are stored on the plurality of devices before they are deleted.

11. The method of claim 10 where setting the duration, according to a selected durability rate, comprises setting the duration, according to a selected durability rate, is determined according to a tiered advertiser schedule.

12. The method of claim 7 further comprising playing the advertisement files at a selected advertisement frequency rate on the plurality of devices.

13. The method of claim 12 where playing the advertisement files at a selected advertisement frequency rate comprises playing the advertisement files at a selected advertisement frequency rate determined according to a tiered advertiser schedule.

14. The method of claim 7 further comprising playing the audio data file through an audio output source in or communicated with the master device.

15. The method of claim 7 further comprising integrating the functionality of the master device into an audio output source.

16. The method of claim 7 further comprising integrating the functionality of the master device into an audio output source.

17. The method of claim 7 further comprising allowing the master device to designate one of the client devices as a successive master device so that the master device functionality is rotated among the plurality of devices.

16. The method of claim 7 further comprising specifying in the master device which of the client devices can access the common playlist and the degree to which the client devices can modify the common playlist.

19. A device for use in a system combining a plurality of such devices in a wireless ad hoc peer-to-peer network, one of which plurality of devices is designated as a master device having a playlist stored therein, the device comprising:
a device discovery module to find the one of the plurality of devices designated as the master device;
a queue for storage of the playlist;
a queue service module to synchronize with the playlist in queue of the master device;
a library module that provides an interface with the music library database, wherein the music library database is a storage for a plurality of audio files;
a communication module to send and receive information among the plurality of devices;
a tangible storage medium for storing information about queues, audio files, and connected devices in the ad hoc network;
a database module to interface with the tangible storage medium;
an audio service module to manage output of audio playback; and
a song data source to stream an audio file to the queue service module, the queue service module communicating the audio file to the audio service module.
